(19) United States
(12) Patent Application Publication
(10) Pub. No.: US 2020/0072159 A1
(43) Pub. Date: Mar. 5, 2020

(54) THERMALLY INSULATING COATING FOR AN ALUMINUM PISTON

(71) Applicant: FEDERAL-MOGUL NURNBERG GMBH, NURNBERG (DE)

(72) Inventors: WOLFRAM CROMME, EZELSDORF (DE); MARGRIT DANNENFELDT, NURNBERG (DE); MONIKA BLUMM, FEUCHT (DE)

(21) Appl. No.: 16/610,615

(22) PCT Filed: May 4, 2018
(86) PCT No.: PCT/EP2018/061520

§ 371 Date: Nov. 4, 2019

(30) Foreign Application Priority Data
May 5, 2017 (DE) 10 2017 207 589.9

(51) Int. Cl. F02F 3/12; C25D 11/02; C25D 11/04; C25D 11/24; C23C 28/04; F02F 3/00; F16J 1/01

(52) U.S. Cl. CPC F02F 3/12; C25D 11/026; C25D 11/04; F02F 2200/00; C23C 28/042; F02F 3/0084; F16J 1/01; C25D 11/246

(57) ABSTRACT

A coated aluminum piston, for an internal combustion engine includes an area of the piston having a plasma oxide layer which is sealed with a coating that comprises a polysilazane-based, a water glass-based or polysiloxane-based polymer. A method of coating the piston is also provided.

### TECHNICAL FIELD

The present invention relates to an aluminum piston, in particular for an internal combustion engine, having a coating which comprises a plasma oxide layer and a sealing layer, and also to a method for the production thereof.

### PRIOR ART

The combustion process in a reciprocating piston engine is very complex. By thermally insulating the combustion chamber, the efficiency of the internal combustion engine can be increased and thus the fuel consumption can be reduced.

Methods for thermally insulating pistons are known in the prior art.

By way of example, use is made of layers applied by thermal spraying. Although this method enables the application of different materials, the adhesion of the resulting layer to the piston crown is nevertheless unsatisfactory in the area of the undercut of the combustion bowl of a diesel engine. In addition, mechanical machining of the layer is necessary in order to achieve a constant layer thickness.

Use is also made of coatings produced by anodizing. However, the layers thus produced have open pores, and therefore the insulating effect thereof is insufficient.

There is therefore a need to provide a coating for aluminum pistons which has a good thermal insulation effect at a suitable thickness and which is easy to produce.

This problem is surprisingly solved by a coating which comprises a plasma oxide layer and a polysilazane-based, water glass-based or polysiloxane-based sealing.

### DETAILED DESCRIPTION OF THE INVENTION

The invention relates to an aluminum piston, in particular an aluminum piston for an internal combustion engine, wherein an area of the piston comprises a plasma oxide layer which is sealed with a coating comprising a polysilazane-based, water glass-based or polysiloxane-based polymer. The present invention also relates to a method for coating a piston in an internal combustion engine, in which a plasma oxide layer is generated on an area of the piston, and a coating comprising a polysilazane-based, water glass-based or polysiloxane-based polymer is applied to said plasma oxide layer.

Advantageously, in the context of the invention, preferably the entire piston crown including the combustion bowl can be provided with the coating for thermal insulation. In one particularly preferred embodiment, only the outer area of the piston crown without the bowl is coated.

The invention can be used to coat in particular pistons made of aluminum alloys, which are used for the gravity casting of engine pistons. These usually have a silicon content of 8 wt % to 20 wt %, preferably 8.5 wt % to 13 wt %. A low copper content of up to 5.4 wt %, preferably 4 wt % or less, is also advantageous since a high copper content can have a negative effect on the plasma oxidation.

According to the invention, a sealing layer which comprises a polysilazane-based, water glass-based or polysiloxane-based polymer (hereinafter also referred to as the polysilazane-based, water glass-based or polysiloxane-based layer) is applied to the plasma oxide layer. Preference is given to a polysilazane-based layer.

The polysilazane-based, water glass-based or polysiloxane-based layer may be a multilayer system, wherein different base materials and/or additives are used for the individual layers. By way of example, use can be made of a double layer which consists of a lower, preferably thin, layer of inorganic polysilazane and an upper layer of organic polysilazane that has been modified using additives.

### a. Polysilazane-Based Coating

Either an inorganic or an organic polysilazane can be used as the base. The inorganic polysilazane used according to the invention forms an amorphous network of Si and N atoms which contains building blocks of formula —(H₂Si—NH)ₙ— and which is also referred to as perhydropolysilazane. In the case of organic polysilazanes, the network is modified by organic groups, which results in building blocks of formula —(R¹R²Si—NH)—. Of course, use can also be made of polymers which contain only one organic group per monomer.

Polysilazane-based coatings are conventionally used for electronic components. The products that are commercially available for this can be used in the context of the invention.

To form inorganic polysilazane, use is made of solutions of perhydropolysilazane in solvents. By way of example, use can be made of 20% perhydropolysilazane in dibutyl ether (for example from Merck).

The organic polysilazanes may have different radicals R¹ and R², e.g. a polysilazane that has been modified by vinyl groups can be used. They may be dissolved in different solvents, such as butyl acetate for example. These solutions may optionally contain further organic admixtures. Examples of suitable organic polysilazanes are HTT 1800 (Merck KGaA) and NTA 1500 (KiON Defense Technologies).

By reaction of the polysilazane with atmospheric moisture, water or alcohol, a polysiloxane layer forms, which in the case of inorganic polysilazane is an amorphous quartz glass layer.

### b. Water Glass-Based Coating

Sodium, potassium or lithium water glass can be used as the base, preference being given to potassium water glass.

### c. Polysiloxane-Based Coating

The base of the polysiloxane-based coating may be polysiloxanes of the following formula:

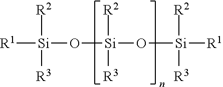

in which R¹ is either H or an alkyl group, preferably H or a C₁-₁₀ alkyl group, more preferably H or a C₁-C₅ alkyl group; and

R² and R³ are each, independently of one another, H or an alkyl group, preferably H or a C₁-C₁₀ alkyl group, more preferably H or a C₁-C₅ alkyl group.

Preference is given to a polysiloxane in which, if R² is H, R³ is an alkyl group and, if R³ is H, R² is an alkyl group.

The alkyl group of R¹, R² and R³ is either a branched or unbranched hydrocarbon chain. Furthermore, the alkyl groups may be substituted with halogens such as F, Cl, Br or I, preferably with F.

Use is preferably made of a high-temperature-resistant polysiloxane.

### d. Plasma Oxide Layer

A piston according to the invention has at least one area which comprises a plasma oxide layer. By way of example, an area of the piston crown, preferably the entire piston crown including the bowl area, may have a plasma oxide layer. With particular preference, only the outer area of the piston crown without the bowl is covered with a plasma oxide layer.

The plasma oxide layer can be generated in a known manner, for example by means of plasma electrolytic oxidation (PEO). Such layers are manufactured for example by Keronite (product name: Keronite), Henkel (ECC or EC2) and AHC (Kepla coat). The layers thus obtained are porous.

In one preferred embodiment, the plasma oxide layer comprises Al₂O₃ and/or TiO₂.

Larger layer thicknesses lead to better thermal insulation. Preference is therefore given to layer thicknesses of the plasma oxide layer in the range of more than 40 μm, particularly preferably from 70 to 130 μm.

### e. Sealing Layer

The plasma oxide layer is sealed by applying to the plasma oxide layer a coating which comprises a polysilazane-based, water glass-based or polysiloxane-based polymer. The polymers penetrate into the pores of the oxide layer and seal said pores.

The thickness of the polysilazane-based, water glass-based or polysiloxane-based coating above the plasma oxide layer is preferably 0.2 μm to 40 μm, wherein large layer thicknesses can usually be produced only by means of organic polysilazanes. The thickness of the polysilazane-based, water glass-based or polysiloxane-based coating, particularly when using inorganic polysilazane, is preferably 0.2 μm to 10 μm and particularly preferably 0.5 μm to 2 μm. The total thickness of the layer consisting of oxide and polysilazane, water glass or polysiloxane thus corresponds to the sum of the thickness of the plasma oxide layer and of the polymer layer covering the latter.

It is possible to modify the polysilazane-based, polysiloxane-based or water glass-based layer by adding additives, for example by adding zirconia powder, BN, enamel glass powder, hollow glass spheres, corundum powder, TiO₂ or the like. These powders advantageously have a particle size of 0.1 μm to 25 μm. In this way, thicker layers can be produced.

By means of organic polysilazanes, layer thicknesses of up to 100 μm can be achieved if a filler, for example ZrO₂, glass powder (hollow glass spheres) and/or TiO₂, is added. In this way, a layer that has a particularly good thermal insulation effect can be produced if necessary.

The glass powders are preferably selected such that the thermal expansion coefficient thereof corresponds approximately to that of the aluminum piston. The average size of the glass particles preferably lies in the range from 3 to 10 μm. Suitable glass systems are, for example, 8472 (lead borate glass), 8470 (borosilicate glass), G018-198 (lead-free passivation glass) and G018-311 (barium silicate glass) from Schott.

The ZrO₂ used may be, for example, powder having an average particle size of 0.3 to 4 μm.

The present invention also relates to a method for producing the layer and its use as a thermal insulation layer for the piston in an internal combustion engine. Said methods comprise oxidizing the piston and applying the above-described polysilazane-based, polysiloxane-based or water glass-based layer to the plasma oxide layer.

The polysilazane-based, polysiloxane-based or water glass-based layer can be applied at room temperature in a manner known to a person skilled in the art, for example by wiping, spraying, dipping or brushing.

The composition thus applied is preferably heated to a temperature of 15° C. to 255° C. for crosslinking purposes.

Over the following days, the polysilazane-based coating transforms under the effect of atmospheric moisture, water or alcohol into an SiO₂-based coating. In all three cases, SiO₂ networks thus form, which have a very low thermal conductivity.

In contrast to the layers known in the prior art, which are produced by means of a sol-gel process, the polysilazane-based, polysiloxane-based or water glass-based sealing layer produced is non-porous and is therefore gas-tight. For this reason, the layer cannot become saturated with fuel, and therefore the coating has no negative effect on the combustion.

In addition, an excellent adhesion of the sealing layer to the plasma oxide layer is ensured because of the bonding between the oxide and the Si—O groups of the sealing layer.

Due to the properties of the polysilazane-based, water glass-based or polysiloxane-based coating, it is not possible to produce large layer thicknesses on pure metal surfaces. By applying the sealing layer to the plasma oxide layer, it is possible to combine the thermally insulating effect of the plasma oxide layer with the gas-impermeable sealing layer, which conducts very little heat, so as to produce an efficient, thermally insulating layer. In addition, due to the low thermal conductivity of the oxide-SiO₂ composite layer, it is possible to increase the combustion temperature and thus to increase the efficiency of combustion.

1-11. (canceled)

12. An aluminum piston having a piston crown, wherein a plasma oxide layer which has a layer thickness in the range of more than 40 μm and which may optionally comprise Al₂O₃ and/or TiO₂ is applied to an area of the piston crown, wherein the plasma oxide layer is sealed with a polysilazane-based, water glass-based or polysiloxane-based layer.

13. The aluminum piston according to claim 12, wherein the entire piston crown is coated.

14. The aluminum piston according to claim 12, wherein the piston crown includes a piston bowl and an outer area around the bowl, wherein the coating is applied to the outer area of the piston crown without the bowl.

15. The aluminum piston according to claim 12, wherein
if a polysilazane-based layer is used, use is made of inorganic or organic polysilazane;
if a polysiloxane-based layer is used, use is made of a high-temperature-resistant polysiloxane; and
if a water glass-based layer is used, use is made of potassium water glass.

16. The aluminum piston according to claim 12, wherein a polysilazane-based layer is used.

17. The aluminum piston according to claim 12, wherein inorganic polysilazane is used.

18. Aluminum piston according to claim 15, wherein the polysilazane-based, water glass-based or polysiloxane-based layer contains ZrO₂, hollow glass spheres and/or TiO₂.

19. The aluminum piston according to claim 12, wherein the plasma oxide layer comprises Al₂O₃ and/or TiO₂.

20. The aluminum piston according to claim 12, wherein the layer thickness of the plasma oxide layer lies in the range from 70 to 130 μm.

21. The aluminum piston according to claim 12, wherein the piston comprises an aluminum piston for an internal combustion engine.

22. A method for coating an aluminum piston, which comprises oxidizing an area of the piston by means of plasma electrolytic oxidation in order to generate a plasma oxide layer, and
sealing the generated plasma oxide layer with a coating which comprises a polysilazane-based, water glass-based or polysiloxane-based polymer.
